(19) United States
(12) Patent Application Publication
(10) Pub. No.: US 2021/0061023 A1
(43) Pub. Date: Mar. 4, 2021

(54) Tire With Hidden Traction Enhancing Sidewall Treads

(71) Applicant: Kenneth Kristopher Towery, Louisville, KY (US)

(72) Inventor: Kenneth Kristopher Towery, Louisville, KY (US)

(21) Appl. No.: 16/550,837

(22) Filed: Aug. 26, 2019

(51) Int. Cl. B60C 13/02; B60C 11/03

(52) U.S. Cl. CPC B60C 13/02; B60C 11/0304

(57) ABSTRACT

An automotive tire is provided with improved traction in snow and mud by providing traction features only on the inside sidewall of the tire which features are therefore hidden when viewed from the outside sides of the vehicle so that the normal appearance of the tire is maintained when viewed from an outer side of a vehicle equipped with the tire while providing improved traction in snow and mud.

### BACKGROUND OF INVENTION

This invention concerns automotive tires, and particularly high performance tires for crisp handling typically installed on expensive sport cart.

These tires are designed for use when driving on pavement and have poor performance on snow or mud. These tires are usually designed to also have an attractive appearance, compatible with the expensive cars on which such tires are typically installed, and traction is sacrificed in favor of aesthetics.

Tires having treads for use on snow and mud are generally not attractive in appearance as prominently visible treads are relied on to enhance traction.

It would be desirable if tires and particularly high performance tires were available which would provide better traction in snow and mud without compromising appearance of the tires.

It is an object of the present invention to provide tires which have improved traction in snow and mud while keeping the typically attractive appearance particularly on high performance tires.

### SUMMARY OF THE INVENTION

The above object is achieved by providing tires having series of spaced apart sidewall traction improving treads which are hidden from view by only providing on the inner side side of the tire. These sidewall tread features are located so as to not contact the road surface to maintain dry pavement performance while not being visible from points on either side of the automobile so as to not affect the appearance of the tire. The sidewall tread features are molded integrally when tire is molded protruding from the outwardly curving sidewalls of the tire. As noted, the traction enhancing features are provided only on one side of the tire located away so as to not be visible while improving the traction thereof.

The sidewall tread may comprise a closely spaced series of blade shaped tread features arrayed around the circumference of the tire sidewall which have a first side extending out from the sidewall in an axial direction (normal to the plane of the tire sidewall). The first side of the features are located slightly below the main treads so that the sidewall features do not contact the pavement to which could adversely affect handling performance.

The series of the sidewall tread features preferably alternate between long and short first side lengths with spaces the features between.

The presence of such tread features provide improved traction in snow and mud.

At the end of the first side of each feature, a second side of each tread extends down vertically, intercepting the tire side wall.

Sidewalls normally curve outwardly from the main tire treads, radially out towards the wheel hole of the tire.

A second version of the sidewall traction improving tread has traction features forming an array of thinner blades, the blades arranged in a V-shape which are juxtaposed in an oppositely orientation along the series.

### DESCRIPTION OF THE DRAWING FIGURES

FIG. 1 is a perspective view of a tire according to the present invention viewed from the inside side side of the tire, and having a circumferentially extending series of sidewall traction tread features a first version comprising outwardly projecting blades molded to be integral with the inner side sidewall of an otherwise conventional tire, the conventional portions shown in outline only.

FIG. 2 is a side view of the inside side of the tire shown in FIG. 1 with conventional portions thereof shown in outline only.

FIG. 3 is an elevational front view of the tire shown in FIG. 4 viewed from the inside side of the sidewall treads comprising traction enhancing features, the conventional portion of the tire are shown in outline only.

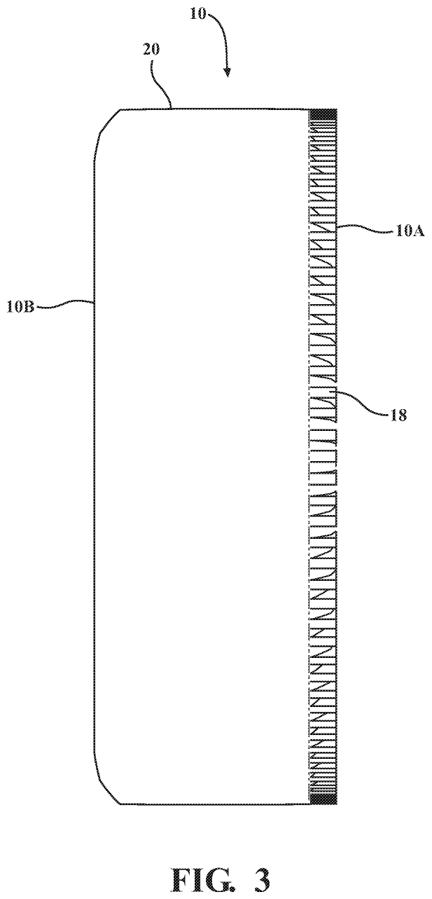

FIG. 4 is an outline of the main portions of the tire, shown in FIG. 3 from the outside side depicting only the conventional portions thereof and showing that the traction features are not visible when viewing the tire from the outside side.

FIG. 5 is a perspective view of a tire from the inside side provided with a second version of the sidewall treads for enhancing traction in mud and snow traction.

FIG. 6 is a side elevational view from the inside side of the tire shown in FIG. 5 with conventional tire portions only shown in outline.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

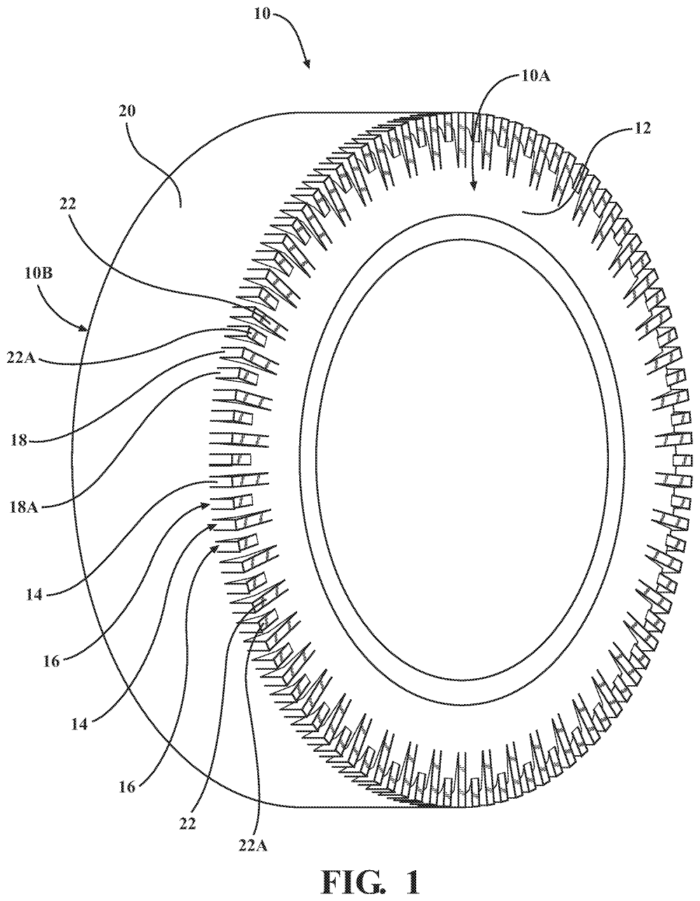

Referring to FIG. 1, a tire 10 is shown as viewed from the inside side 10A which is not hidden from a viewer standing along either side of the car. The inner sidewall 12 is provided with an alternating series of spaced apart sidewall tread traction features 14 and 16 extending around the circumference of the inner side 10A of the tire 10 only. The opposite outer side 10B not formed with those features to thus preserve the good appearance of the tire as originally designed.

Both sets of features 14, 16 are integrally molded with the inside sidewall 12.

The traction features 14, 16 are both blade shapes formed by respective upper sides 18, 18A projecting normally from the plane of the tire 10.

The sides 18, 18A are at a radial location just below the level of the main tread 20, (not illustrated) so that the sides 18, 18A do not touch the pavement, and thereby don't affect normal tire performance.

The sides 18, 18A extend inwardly radially a relatively short distance, i.e., a matter of one inch for the shorter sides 18A to several inches for the longer sides 18.

These lengths are not critical.

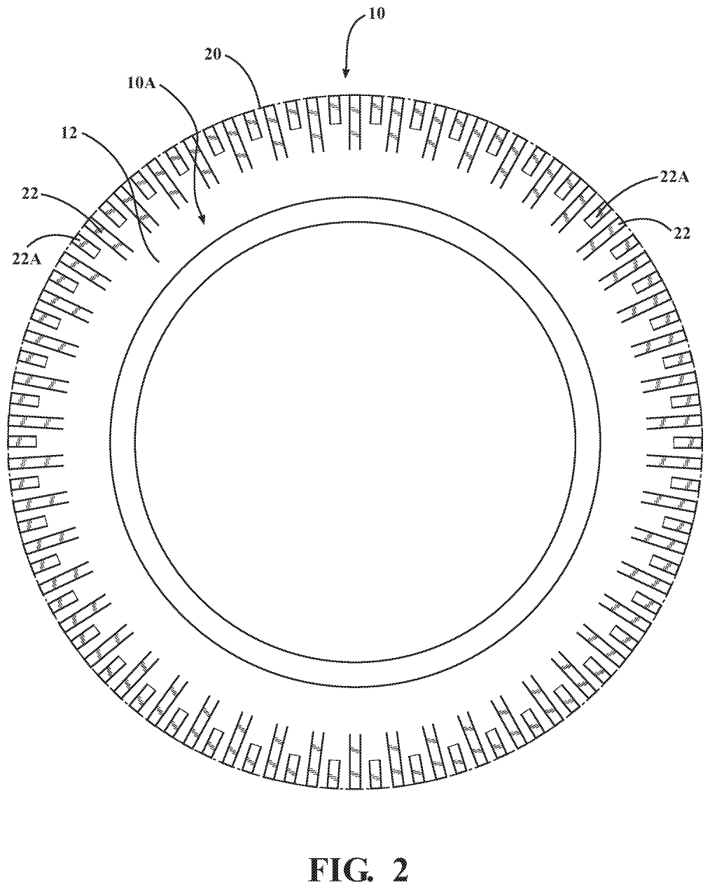

At the end of each side 18, 18A is a second side 22, 22A (FIG. 2) extending radially at right angles to a respective side 18, 18A extending to the point of intersection with the conventional outward curving surface of the sidewall 12 (FIGS. 2,3).

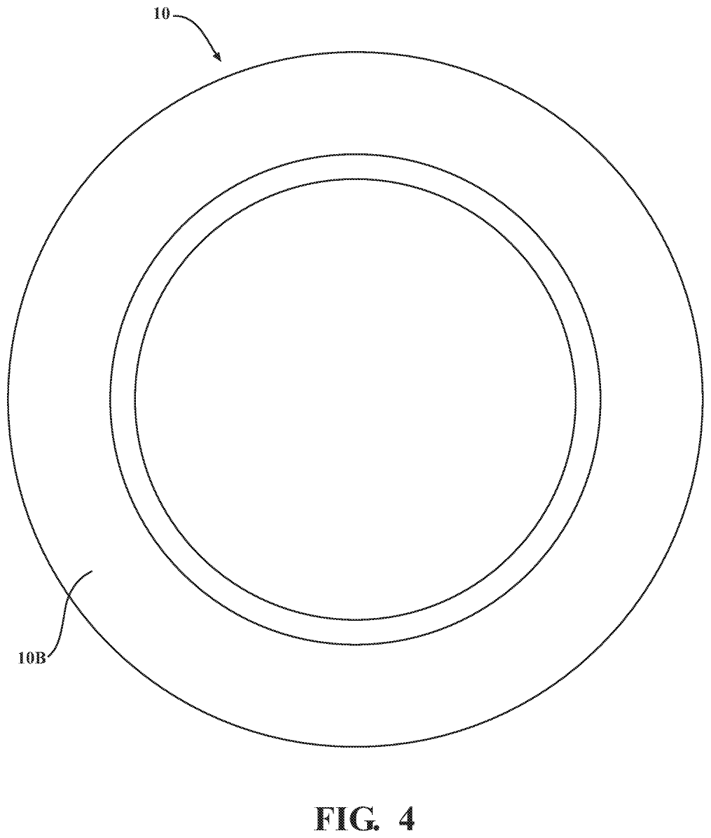

FIG. 4 shows the outside side 10B of the tire 10, and it can be seen that the traction features 14, 16 cannot be seen from the outside side 10B of the tire 10.

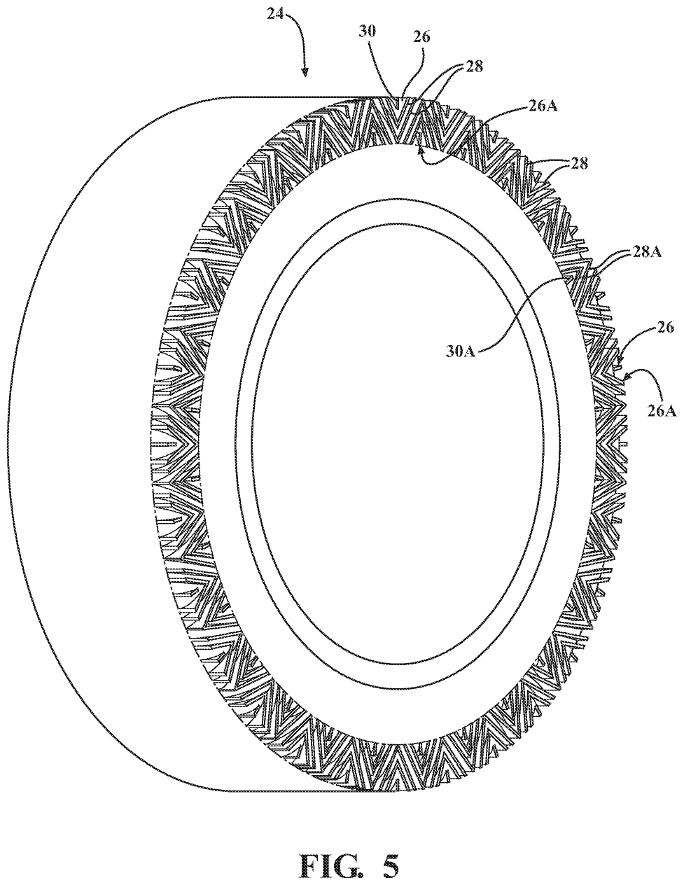

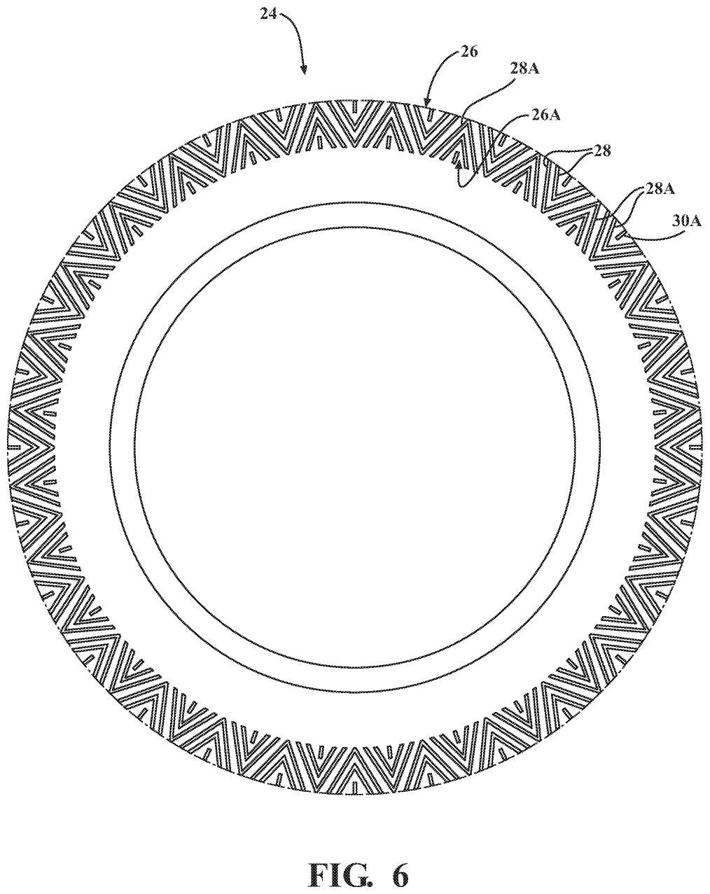

FIGS. 5 and 6 show a tire 24 having another version of the sidewall tread which are alternately oriented triangularly shaped traction features 26, 26A made up of an array of inner blade sets comprised of two angled pieces 28, 28A and a short straight piece 30, 30A.

1. An automotive tire having a conventional main tread and a conventional sidewall adapted to be facing outside when the tire is installed and an inside sidewall when installed, formed with a circumferential array of traction enhancing spaced apart features projecting normally from said inside sidewall provided by being molded with said inside sidewall, said features located just below said radially inward from said conventional main tread so as that said features do not contact pavement on which said main tread rests.

2. The tire according to claim 1 wherein said features are spaced apart from each other along said circumferential array.

3. The tire according to claim 2 wherein said features are successively shorter and longer in a direction normal to a plane of said tire.
